(19) United States
(12) Patent Application Publication
(10) Pub. No.: US 2004/0097273 A1
(43) Pub. Date: May 20, 2004

(54) Portable amplification set & ear set interchangeable hand-free kit

(76) Inventor: Michael Chiang, Panchiao City (TW)

Correspondence Address: Michael Chiang, PO Box 82-144, Taipei, TW

(21) Appl. No.: 10/671,675

(22) Filed: Sep. 29, 2003

(30) Foreign Application Priority Data
Nov. 19, 2002 (TW) 091218537

(51) Int. Cl. H04M 1/00

(52) U.S. Cl. 455/569.1; 455/575.1; 455/90.2; 455/90.3

(57) ABSTRACT

A portable hand-free kit comprised of an amplification set and an ear set within interchangeable talking modes, the amplification set including a front casing and a rear casing buckled to each other, a PCB locked between both casings adapted to a mobile hand-set; a conduction circuit laid on the PCB adapted with a microphone, a speaker, a rechargeable battery and a switch to shuttle between two conversation modes; and the amplification set being buckled to the ear set allowing conversation in the amplification talking mode or switch to the ear set talking mode if privacy is desired.

### BACKGROUND OF THE INVENTION

(a) Technical Field of the Invention

The present invention is related to a portable amplification set and ear set interchangeable hand-free kit, and more particularly, to one that allows hand-free conversation in amplification mode or in ear set mode by operating a circuit switch.

(b) Description of the Prior Art

Mobile hand-free ear sets generally available in the market though provided with practical features of being company and convenient could cause its user uncomfortable ears after having worn for a certain period of time. To correct the problem, an improvement is made a hand-free amplification structure. However the improvement for being large in size and complicate in structure is usually for a stationery use, such a hand-free ear set provided in a car or mobile group for independent operation addressing a particularly operation environment. The present invention by integrating the features of both prior arts provides a portable hand-free kit allowing interchangeable operation modes of amplification and ear set in one by clipping the kit to the body of the user for hand-free conversation in amplification mode and for hand-free private conversation in ear set mode to better meet consumer practical needs.

### SUMMARY OF THE INVENTION

The primary purpose of the present invention is to provide a portable amplification set and ear set hand-free kit. A hand-free ear set is buckled to the hand-free amplification set with the conversation modes interchangeable by operating a circuit switch. A microphone and a speaker are provided to a PCB inside the casing to receive message and amplify the sound from the talker, and the amplification set is buckled with a hook and a tongue to a trough on the hand-free ear set to interchange the talking modes for achieving the purpose of conversation through the hand-free amplification set or a coil spring wired ear set.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a hand-free amplification set of a preferred embodiment of the present invention.

FIG. 2 is a perspective view of the hand-free amplification set of the preferred embodiment of the present invention as assembled.

FIG. 3A is an elevated view of the hand-free amplification set of the preferred embodiment of the present invention.

FIG. 3B is a side sectional view of the preferred embodiment of the present invention.

FIG. 4 is a view showing the hand-free amplification set is adapted with a hand-free ear set of the preferred embodiment of the present invention.

FIG. 5 is a view showing an assembly of the preferred embodiment of the present invention.

FIG. 6 is a schematic view showing an operation type of the preferred embodiment of the present invention.

FIG. 7 is a schematic view showing another operation type of the preferred embodiment of the present invention.

FIG. 8 is a schematic view showing another operation type yet of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

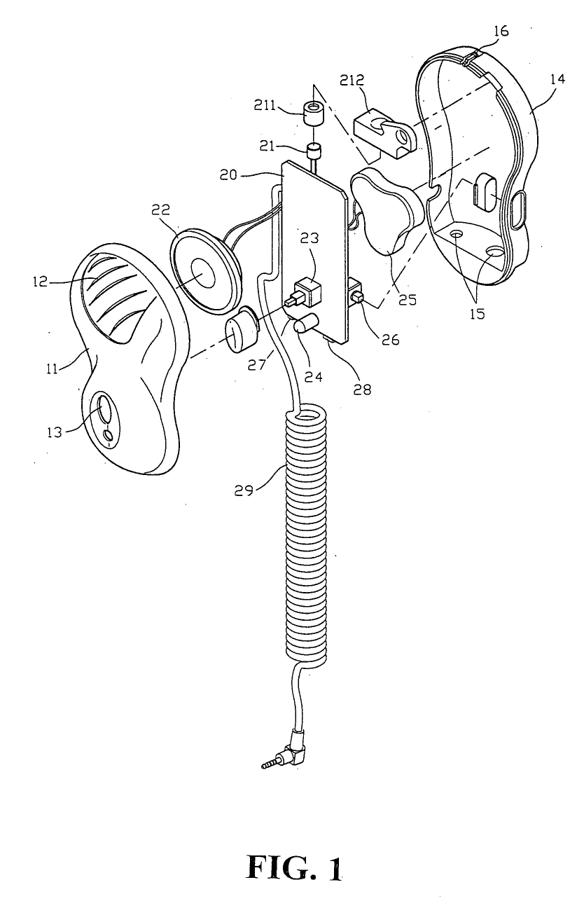

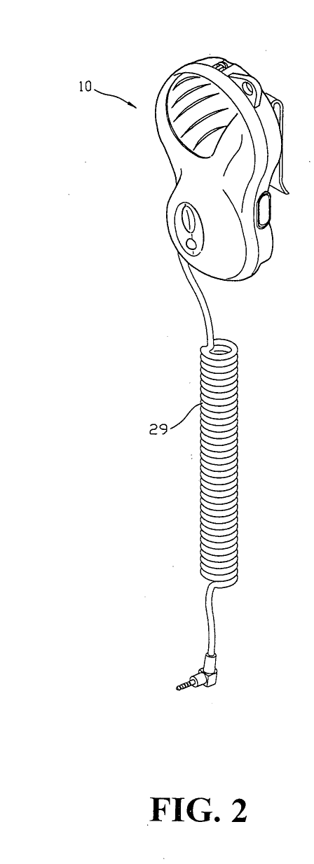

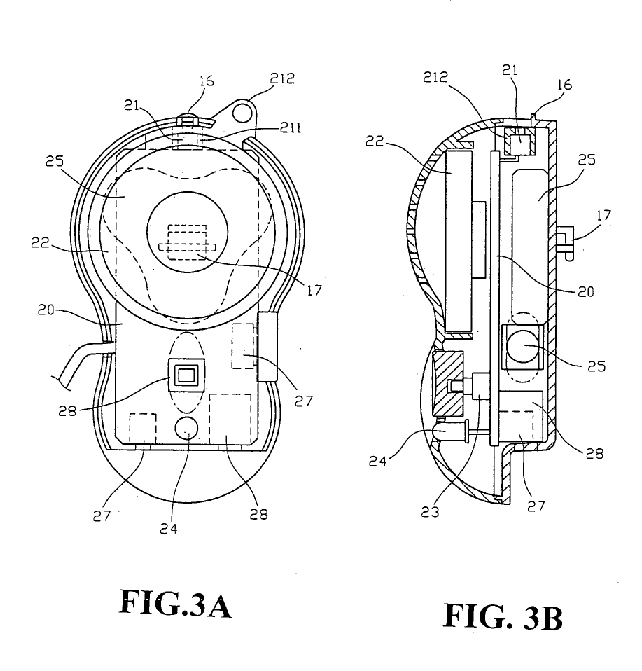

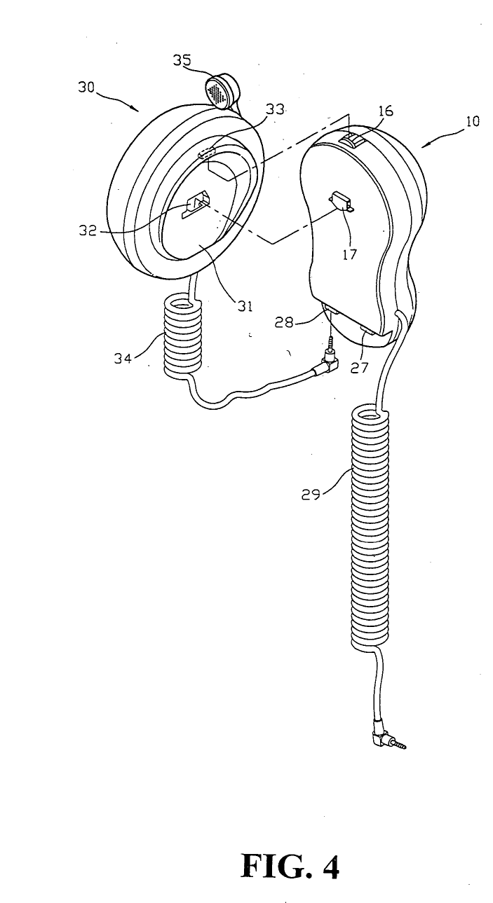

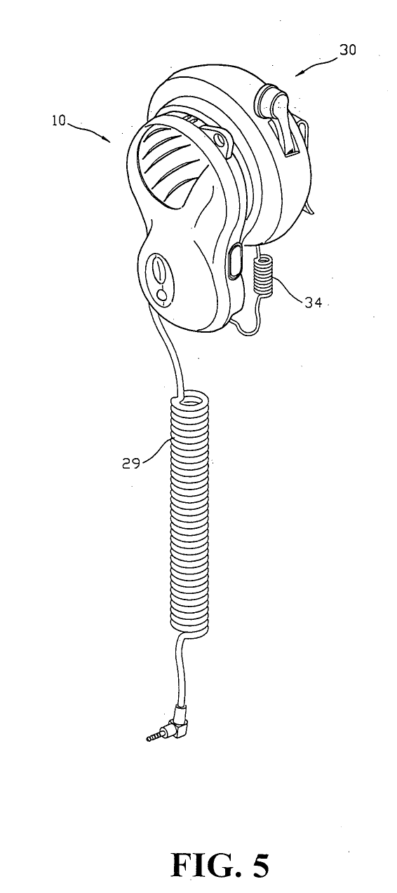

Referring to FIGS. 1, 2, 3A, and 3B, a preferred embodiment of the present invention for a portable amplification set and ear set interchangeable hand-free kit is essentially comprised of a hand-free amplification set 10 containing a front casing 11 and a rear casing 14 buckled to each other, a PCB 20 installed inside the amplification set 10 is connected in series to a mobile handset by means of a transmission wire 29, and a hand-free ear set casing 30 detachable to the amplification set 10 by means of a transmission wire 34. Wherein, multiple slots 12 and holes 13 are reserved on the front casing 11 for conversation, and mounting of a switch and an indicator. Multiple holes 15 are also provided on the rear casing 14 to receive plugging by another switch and the transmission wire 29. A buckling tongue 16 is extended from the upper edge of the rear casing 14 and a hook 17 is extended from the back of the rear casing 14 at where close to its top for the amplification set 10 to be buckled to the hand-free ear set casing 30 for integrated operation as illustrated in FIGS. 4 and 5. Furthermore, multiple threaded studs (not illustrated) are provided inside the rear casing 14 to hold the PCB 20 in position between both of the front casing 11 and the rear casing 14.

A conduction circuit is laid on the PCB 20 and the PCB 20 is connected to a microphone 21 and a speaker 22 for receiving and transmitting messages during the conversation. The microphone 21 is inserted into a locking cap 211 and fixed by means of a locking member 212 to the rear casing 14. A switch 23 and an LED 24 are soldered to the lower part on the front of the PCB 20 while on the other side of the PCB 20 is provided with a rechargeable batter 25. A recharging socket 27 and a hand-free ear set communication socket 28 are respectively provided at where close to the lower edge of the PCB, and another switch 26 is provided on the lower part on the back of the PCB 20. The transmission wire 29 is extended from a selected side of the PCB 20 to plug in a socket on a mobile handset.

As illustrated in FIGS. 4 and 5, the hand-free ear set casing 30 is provided with a recessed holder 31. A trough 32 and a recess 33 respectively to receive the buckling by the hook 17 and the tongue 16 from the casing of the hand-free amplifier set 10 and another transmission wire 34 suspending from the hand-free ear set casing 30 is plugged into the communication socket 38 for the hand-free ear set provided at the lower edge of the hand-free amplification set 10 while the transmission wire 29 extending from the lower edge of the hand-free amplification set 10 is plugged to the socket of the mobile hand-set. To separate the hand-free amplification set from the hand-free ear set casing 30, simply push at the lower edge of the casing of the hand-free amplification set 10 towards the hand-free ear set to avoid falling off of the hand-free amplification set 10 by accidental pulling up or impact against the hand-free amplification set 10.

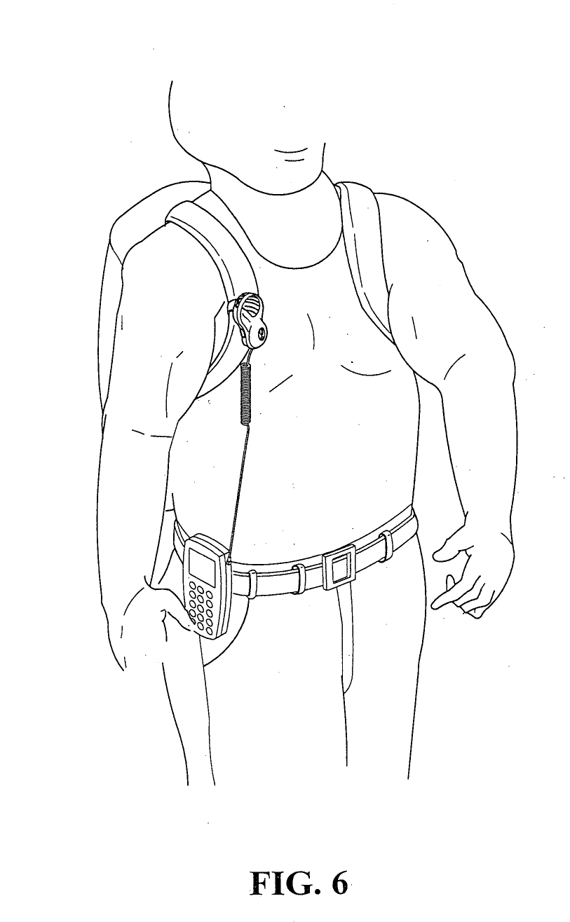

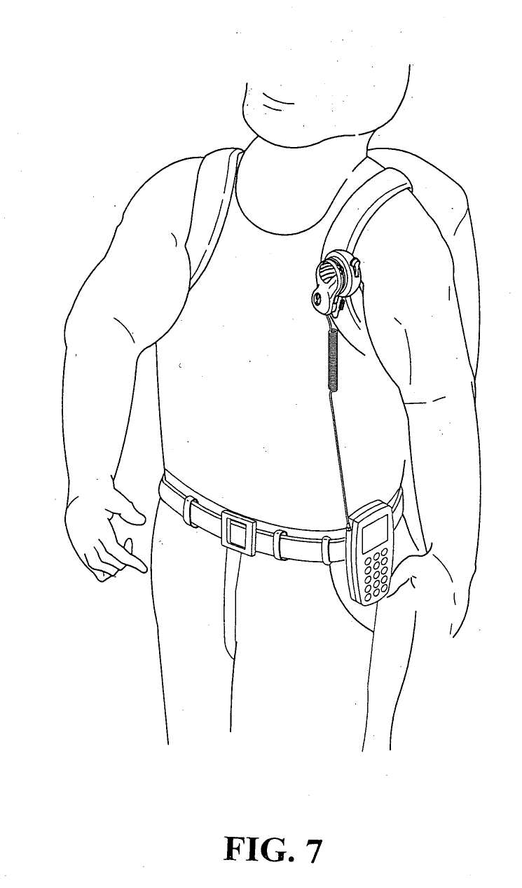

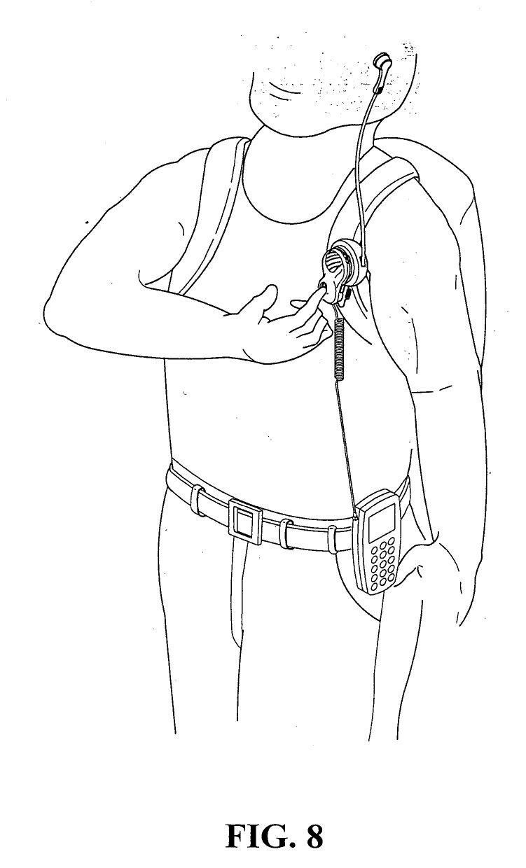

The switch 23 on the casing of the hand-free amplification set 10 is provided as an optional switch to shuttle between two conversation modes. In hand-free amplification set talking mode, the microphone 21 and the speaker 22 fixed to the PCB 20 inside the casing of the hand-free amplification set 10 are used for the conversation with or without the attachment of the hand-free ear set as respectively illustrated in FIGS. 6 and 7. If privacy is desired for the conversation, the switch is turned to the hand-free ear set talking mode through a retractable ear set 35 as illustrated in FIG. 8. The present invention by allowing the standing-alone operation with the hand-free amplification set or an interchangeable operation of the hand-free amplification set integrated with the hand-free ear set provides its user fast, convenient and private operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable amplification and ear set interchangeable hand-free kit is comprised of a hand-free amplification set including a front casing and a rear casing buckled to each other, a PCB fastened in position inside the casings connected in series to a mobile handset connected by means of a transmission wire, and a hand-free ear set; wherein, the front casing being provided with multiple slots and holes for conversation and mounting of a switch and an indicator; the rear casing being provided with multiple holes to reserve insertion of another switch and the transmission wire; a tongue being extended from the upper edge of the rear casing, a hook being extended from the back of the rear casing at where close to the top of the rear casing; both of the tongue and the hook being used to buckle up the hand-free ear set casing for integrated operation, multiple threaded studs being provided in both casings to lock up the PCB at where between two casings with screws; the PCB laid with conduction circuit being connected with a microphone and a speaker for receiving and transmission of messages during the conversation; the microphone being inserted into a locking cap; the microphone being fixed to the rear casing by means of a locking member; a switch and an LED being soldered to the lower part on the front edge of the PCB; a rechargeable battery being provided on the other side of the PCB, two sockets and another switch being soldered to where closed to the lower edge of the PCB; both sockets being respectively provided for receiving the plug in by a recharging unit and the hand-free ear set; and the transmission wire extending by a selected side of the PCB plugging into a socket from the mobile handset; characterized by that the present invention allows interchangeable conversation modes between the hand-free transmission set and the hand-free ear set by operating the circuit switch if privacy is desired during the conversation.

2. A portable amplification and ear set interchangeable hand-free kit as claimed in claim 1; wherein, a retractable clip is provided at the hook on the backside of the casing.
